(19) United States
(12) Patent Application Publication
(10) Pub. No.: US 2023/0380446 A1
(43) Pub. Date: Nov. 30, 2023

(54) PLANT-BASED SHREDDED MEAT PRODUCTS, AND METHODS OF PRODUCING THE SAME

(71) Applicant: Tender Food, Inc., Somerville, MA (US)

(72) Inventors: Luke MACQUEEN, Cambridge, MA (US); Grant GONZALEZ, Somerville, MA (US); Matthew SKINNER, Somerville, MA (US); Jade Elizabeth ZHU, Cambridge, MA (US); Sangita VASIKARAN, Plano, TX (US); Richard COLWELL, Somerville, MA (US); Avinash SHRIKANTIA, Norwood, MA (US); Clémence Jehl DE MÉNORVAL, Wilmington, MA (US); John Andrew GETSY, IV, Boston, MA (US); Hung PHAM, Amherst, MA (US); Geneviève Catherine NORRIS-ROOZMON, Toronto (CA); Jasmin Anne KERN, Boston, MA (US)

(73) Assignee: Tender Food, Inc., Somerville, MA (US)

(21) Appl. No.: 18/126,756

(22) Filed: Mar. 27, 2023

Related U.S. Application Data
(60) Provisional application No. 63/346,172, filed on May 26, 2022.

(51) Int. Cl. A23J 3/22; A23J 3/14; A23L 5/30

(52) U.S. Cl. CPC A23J 3/227; A23J 3/14; A23L 5/30

(57) ABSTRACT

Embodiments described herein relate to methods of forming fibrous food products. In some aspects, a method can include mixing a composition with a solvent to form a first solution, the first solution including between about 15 wt % and about 40 wt % of the composition, the composition including a plant protein and a polysaccharide. The method further includes causing ejection of a second solution in a jet, collecting the jet of the second solution in a precipitation bath, such that a collection of fibers forms, drying the collection of fibers, and pulling apart the collection of fibers, and adding a fat and a flavoring to the collection of fibers to form the fibrous food product. In some embodiments, the method can further include heating the second solution to a temperature between about 40° C. and about 90° C. during the mixing and/or causing the ejection.

### CROSS REFERENCE TO RELATED APPLICATIONS

This application claims the benefit of U.S. Provisional Application No. 63/346,172, titled “Plant-Based Shredded Meat Products, and Methods of Producing the Same,” and filed May 26, 2022, the content of which is incorporated herein by reference in its entirety.

### STATEMENT REGARDING FEDERALLY SPONSORED RESEARCH

This invention was made with government support under 2112169 awarded by the National Science Foundation. The government has certain rights in the invention.

### TECHNICAL FIELD

Embodiments described herein relate to plant-based shredded meat products and methods of producing the same.

### BACKGROUND

Shredded or “pulled” meat products are featured in cuisines throughout the world. American “pulled pork” barbecue dish is a prominent example. Slow cooking, smoking, or pressure cooking are often used to soften meat cuts, making them easier to shred or pull apart. The ability to shred or pull apart meat results from the fibrillar structure of muscle tissues. The majority of the composition of meats are from the muscle tissue of an animal, and muscle contains bundles of cells called muscle fibers that are long and thin. When the connective tissue holding the fibers together is broken down by cooking (e.g., pressure cooking or slow cooking), the muscle fibers can be easily pulled apart, resulting in the characteristic soft and stringy mechanical properties of pulled or shredded meats. Animal-free alternatives to pulled pork have often employed plants with inherent fiber-like textures (e.g., jackfruit) to recreate the fiber-like texture of muscle tissues. A few specific fibrous plant sources limit the variety of protein sources that can be incorporated into pulled meat products.

### SUMMARY

Embodiments described herein relate to methods of forming fibrous food products. In some aspects, a method can include mixing a substance with a solvent to form a first solution, the first solution including between about 15 wt % and about 40 wt % of the substance, the substance including a plant protein and a polysaccharide. The method further includes causing ejection of a second solution in a jet, collecting the jet of the second solution in a precipitation bath, such that a collection of fibers forms, drying the collection of fibers, and pulling apart the collection of fibers, and adding a fat and a flavoring to the collection of fibers to form the fibrous food product. In some embodiments, the method can further include heating the second solution to a temperature between about 40° C. and about 90° C. during the mixing and/or causing the ejection. In some embodiments, the method can further include adding an acid to the first solution, such that the first solution includes less than about 5 wt % of the acid.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. Optional items in all figures shown in dashed lines.

FIG. 1 is a block diagram of a method of producing a plant-based shredded meat product, according to an embodiment.

FIG. 2 is a block diagram of a fibrous food product, according to an embodiment.

FIGS. 3A-3D show a fibrous scaffolding with highly aligned, densely packed, individual plant-based fibers, and orientation data associated therewith.

FIG. 4 shows a microscopic view of a plant-based fiber.

FIGS. 5A-5B show microscopic views of a fiber of a plant-based product, as compared to a pork floss fiber.

FIGS. 6A-6E show comparisons of raw beef steak and plant-based fibers.

FIGS. 7A-7B show microscopic views of individual plant-based fibers.

FIGS. 8A-8B show comparisons of a plant-based fiber scaffold, as compared to commercially available beef jerky.

### DETAILED DESCRIPTION

To recreate the fiber-like texture of muscle tissues, animal-free alternatives to pulled pork employ plants with fiber-like textures (e.g., jackfruit) or other texturizing technologies. When specific plants are used for texture, they also bring unwanted organoleptic properties that make them distinguishable from animal-based meat products. To overcome the limitations of fibrous plant supply, methods described herein combine a large variety of non-animal proteins into nutritious fiber-forming material blends that can be extruded, aligned, bundled, and packed together into fibrillar meat substitutes with realistic texture and pulling or shredding characteristics.

Alternatively, texturizing technologies can be applied to plant-based protein blends to produce a fibrous texture similar to that of shredded meats. Texturing technologies include high moisture extrusion. High moisture extrusion is a continuous process and can include mixing solutions in a barrel that are then fed to a twin-screw extruder. The twin-screw extruder can operate in the temperature range 100-175° C. with residence times in the twin-screw extruder between about 2 minutes and about 5 minutes. Such processes can result in a mostly layered structure. Wet texturization has become common, as twin-screw extrusion in combination with chemical and physical processes (thermomechanical cooking and die fibration) to produce a more fibrous structure and meat-like texture of resulting products.

Texturizing technologies aim to broaden available protein precursors, but suffer from several disadvantages. First, high moisture extrusion can impart a fibrous texture to plant-based materials but cannot generate individual fibers such as those found in meats made from animals. This is an important limitation of the industry standard technology, as it fails to recapitulate this important structural feature of animal-based meats.

Shear cell technology is an emerging technology that uses high-temperature conical shear to produce fibrous structures. Shear cell technology is a batch process that can operate in a temperature range of about 90° C. to about 140° C. with residence times of at least about 20 minutes in the shearing device. Shear cell technology uses a high-temperature conical shear cell to produce fibrous textures, but this technology suffers the same key limitation as high moisture extrusion because it does not produce individual fibers and therefore cannot recreate the fine structure of the meat muscle.

Wet spinning is also a process where a protein solution is extruded into a coagulation bath containing a solvent to promote coagulation and fiber formation. Wet spinning throughput can be too low for food production, as throughput scales inversely with fiber diameter and fine fibers (e.g., less than about 100 μm in diameter) are important components of shredded meat products.

3D-printing and fiber spinning technologies have been investigated to recreate the fibrous structure of animal-based meats using plant proteins. 3-D printing is a nozzle extrusion system, where the extrusion head or substrate can be moved relative to each other during extrusion. Fiber manufacturing methods, including electrospinning, blow spinning, and jet spinning. For 3D-printing, production throughput scales inversely with extrusion nozzle size. This can make the production of individual 20-150 μm fibers impractical and not economically viable.

High moisture extrusion and shear cell technologies have often been poorly suited for pulled meat products because they do not produce individual protein fibers at the scale of animal muscle fibers. Of the texturing methods described above, only 3D-printing or fiber manufacturing methods produce individual protein fibers having diameters in the range of animal muscle fibers. Industry reliance on a small number of fibrous plant sources can limit the variety of proteins that can be incorporated into pulled meat products.

Fiber manufacturing methods include electrospinning, blow spinning, and jet spinning. Of these fiber manufacturing methods, it has been demonstrated that jet spinning can produce micrometer-scale fibers at sufficient rates for food production. Furthermore, fiber spinning methods that rely on evaporative fiber forming mechanisms can be restricted to the use of volatile solvents that significantly limit the range of plant-based materials that can be converted into fibrous form using food-safe processes. The use of volatile solvents also degrades protein structures, making electrospinning and blow spinning unattractive to plant-based meat formulations aiming to retain protein structure and nutrition.

Embodiments described herein include plant-based products intended to mimic pork, pulled pork, mammalian meat, avian meat, fish meat, crustacean meat, mollusk meat, or combinations thereof.

Some embodiments described herein relate to methods that include rotary jet spinning to produce fibrous food products. Examples of jet spinning methods are described in greater detail in U.S. Pat. No. 11,174,571 (“the '571 patent”), titled “Immersed Rotary Jet Spinning (iRJS) Devices and Uses Thereof,” the disclosure of which is hereby incorporated by reference in its entirety.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of fibers, the set of fibers can be considered as one electrode with multiple portions, or the set of electrodes can be considered as multiple, distinct fibers. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

The term “progenitor cell” is used herein to refer to cells that have a cellular phenotype that is more primitive (e.g., is at an earlier step along a developmental pathway or progression than is a fully differentiated cell) relative to a cell which it can give rise to by differentiation. Often, progenitor cells also have significant or very high proliferative potential. Progenitor cells can give rise to multiple distinct differentiated cell types or to a single differentiated cell type, depending on the developmental pathway and on the environment in which the cells develop and differentiate.

The term “stem cell” as used herein, refers to an undifferentiated cell which is capable of proliferation and giving rise to more progenitor cells having the ability to generate a large number of mother cells that can in turn give rise to differentiated, or differentiable daughter cells. The daughter cells themselves can be induced to proliferate and produce progeny that subsequently differentiate into one or more mature cell types, while also retaining one or more cells with parental developmental potential. The term “stem cell” refers to a subset of progenitors that have the capacity or potential, under particular circumstances, to differentiate to a more specialized or differentiated phenotype, and which retains the capacity, under certain circumstances, to proliferate without substantially differentiating. In one embodiment, the term stem cell refers generally to a naturally occurring mother cell whose descendants (progeny) specialize, often in different directions, by differentiation, e.g., by acquiring completely individual characters, as occurs in progressive diversification of embryonic cells and tissues. Cellular differentiation is a complex process typically occurring through many cell divisions. A differentiated cell may derive from a multipotent cell which itself is derived from a multipotent cell, and so on. While each of these multipotent cells may be considered stem cells, the range of cell types each can give rise to may vary considerably. Some differentiated cells also have the capacity to give rise to cells of greater developmental potential. Such capacity may be natural or may be induced artificially upon treatment with various factors. In many biological instances, stem cells are also “multipotent” because they can produce progeny of more than one distinct cell type, but this is not required for “stem-ness.” Self-renewal is the other classical part of the stem cell definition. In theory, self-renewal can occur by either of two major mechanisms. Stem cells may divide asymmetrically, with one daughter retaining the stem state and the other daughter expressing some distinct other specific function and phenotype. Alternatively, some of the stem cells in a population can divide symmetrically into two stems, thus maintaining some stem cells in the population as a whole, while other cells in the population give rise to differentiated progeny only. Formally, it is possible that cells that begin as stem cells might proceed toward a differentiated phenotype, but then “reverse” and re-express the stem cell phenotype, a term often referred to as “dedifferentiation” or “reprogramming” or “retrodifferentiation.”

The term “embryonic stem cell” is used to refer to the pluripotent stem cells of the inner cell mass of the embryonic blastocyst (see U.S. Pat. Nos. 5,843,780, 6,200,806, the contents of which are incorporated herein by reference). Such cells can similarly be obtained from the inner cell mass of blastocysts derived from somatic cell nuclear transfer (see, for example, U.S. Pat. Nos. 5,945,577, 5,994,619, 6,235,970, which are incorporated herein by reference). The distinguishing characteristics of an embryonic stem cell define an embryonic stem cell phenotype. Accordingly, a cell has the phenotype of an embryonic stem cell if it possesses one or more of the unique characteristics of an embryonic stem cell such that that cell can be distinguished from other cells. Exemplary distinguishing embryonic stem cell characteristics include, without limitation, gene expression profile, proliferative capacity, differentiation capacity, karyotype, responsiveness to particular culture conditions, and the like.

The term “adult stem cell” or “ASC” is used to refer to any multipotent stem cell derived from non-embryonic tissue, including fetal, juvenile, and adult tissue. Stem cells have been isolated from a wide variety of adult tissues including blood, bone marrow, brain, olfactory epithelium, skin, pancreas, skeletal muscle, and cardiac muscle. Each of these stem cells can be characterized based on gene expression, factor responsiveness, and morphology in culture. Exemplary adult stem cells include neural stem cells, neural crest stem cells, mesenchymal stem cells, hematopoietic stem cells, and pancreatic stem cells.

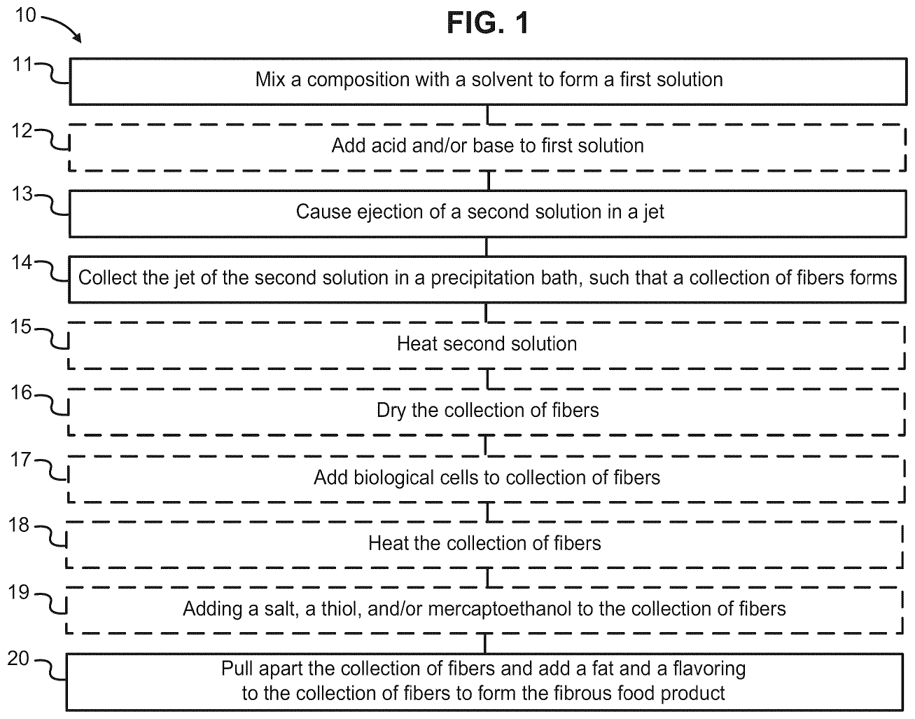

FIG. 1 is a block diagram of a method 10 of producing a fibrous food product, according to an embodiment. As shown, the method 10 includes mixing a composition with a solvent to form a first solution at step 11. The method 10 optionally includes adding an acid and/or a base to the first solution. The method 10 further includes causing ejection of a second solution in a jet at step 13 and collecting the jet of the second solution in a precipitation bath at step 14, such that a collection of fibers forms. The method 10 optionally includes heating the second solution at step 15. The method 10 optionally includes drying the collection of fibers at step 16. The method 10 optionally includes adding biological cells to the collection of fibers at step 17, heating the collection of fibers at step 18, and adding a salt, a thiol, and/or mercaptoethanol to the collection of fibers at step 19. At step 20, the method 10 includes pulling apart the collection of fibers and adding a fat and a flavoring to the collection of fibers to form the fibrous food product.

Step 11 includes mixing a composition with a solvent to form a first solution. The composition can include a plant protein. In some embodiments, the plant protein can include rice, peas, soy, barley, rice, barley rice, beans, fava beans, seitan, tempeh, edamame, lentils, chickpeas, nutritional yeast, spelt, teff, seeds, hemp seeds, amaranth, quinoa, spirulina, green peas, oats, Ezekiel bread, wild rice, nuts, chia seeds, mycoprotein, or any combination thereof. In some embodiments, the composition can include a fungal protein. In some embodiments, the composition can include a bacterial protein. In some embodiments, the composition can include a polysaccharide. The polysaccharide can aid in gelation of the fibrous food product. In some embodiments, the polysaccharide can include cellulose, curdlan, starch, glycogen, sucrose, dextrin, hemicellulose, polydextrose, inulin, glucans, beta-glucan, pectin, psyllium husk mucilage, galactomannans, gums, beta-mannan, carob, fenugreek, guar gum, tara gum, methylcellulose, glucomannan gum, konjac gum, gum acacia, karaya gum, pullulan, tragacanth gum, arabinoxylan gum, xanthan gum, agar, alginate, carrageenan, chitin, chitosan, trehalose, or any combination thereof. In some embodiments, the plant protein can be fermented. In some embodiments, the plant protein can be produced by microorganisms like yeast rather than grown in plants.

In some embodiments, the composition can include a powder. In some embodiments, the powder can have a particle size of at least about 500 nm, at least about 600 nm, at least about 700 nm, at least about 800 nm, at least about 900 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, or at least about 900 μm. In some embodiments, the powder can have a particle size of no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, no more than about 1 μm, no more than about 900 nm, no more than about 800 nm, no more than about 700 nm, or no more than about 600 nm.

Combinations of the above-referenced particle sizes are also possible (e.g., at least about 500 nm and no more than about 1 mm or at least about 30 μm and no more than about 300 μm), inclusive of all values and ranges therebetween. In some embodiments, the powder can have a particle size of about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about μm, about 80 μm, about 90 μm, about 100 μm, about 200 μm, about 300 μm, about 400 μm, about 500 μm, about 600 μm, about 700 μm, about 800 μm, about 900 μm, or about 1 mm.

In some embodiments, the solvent of the first solution can include water. In some embodiments, the solvent of the first solution can include water, ethanol, glycerol, or any combination thereof. In some embodiments, the first solution can be food safe. In some embodiments, the first solution can be organic (i.e., relating to or derived from living matter). In some embodiments, the first solution can be certified organic, as defined by the United States Department of Agriculture (USDA). In some embodiments, the first solution can be composed of ingredients produced via processes overseen by the USDA's National Organic Program (NOP), and/or a certifying agent thereof. In some embodiments, the ingredients of the first solution can be produced following USDA regulations in certifying the organic character of the ingredients. In some embodiments, the components of the first solution can be produced using “allowed substances” for organic certification, as designated by the USDA in 7 U.S.C. § 205(g). In some embodiments, the first solution can include ingredients that are 100 wt % organic, excluding salt and water, as defined by the USDA (i.e., the ingredients can meet the criteria for USDA's “100% organic” label). In some embodiments, the first solution can include ingredients that are at least wt % organic, excluding salt and water, as defined by the USDA (i.e., the ingredients can meet the criteria for USDA's “organic” label). In some embodiments, the first solution can include ingredients that are at least 70 wt % organic, excluding salt and water, as defined by the USDA (i.e., the ingredients can meet the criteria for USDA's “Made with Organic______” label).

In some embodiments, the solvent of the first solution can include a mixture of water and ethanol in various proportions (e.g., about 10 wt %, about 20 wt %, about 30 wt %, about 40 wt %, about 50 wt %, about 60 wt %, about 70 wt %, about 80 wt %, about 90 wt % water, inclusive of all values and ranges therebetween). In some embodiments, the composition can make up at least about 10 wt %, at least about 15 wt %, at least about 20 wt %, at least about 25 wt %, at least about wt %, at least about 35 wt %, at least about 40 wt %, or at least about 45 wt % of the first solution. In some embodiments, the composition can make up no more than about 50 wt %, no more than about 45 wt %, no more than about 40 wt %, no more than about 35 wt %, no more than about 30 wt %, no more than about 25 wt %, no more than about 20 wt %, or no more than about 15 wt % of the first solution. Combinations of the above-referenced weight percentages are also possible (e.g., at least about 10 wt % and no more than about 50 wt % or at least about 20 wt % and no more than about 40 wt %), inclusive of all values and ranges therebetween. In some embodiments, the composition can make up about 10 wt %, about 15 wt %, about 20 wt %, about 25 wt %, about 30 wt %, about 35 wt %, about 40 wt %, about 45 wt %, or about 50 wt % of the first solution.

In some embodiments, an oil can be added to the first solution. In some embodiments, the oil can make up at least about 0 wt %, at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, or at least about 14 wt % of the first solution. In some embodiments, the oil can make up no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, or no more than about 1 wt % of the first solution. Combinations of the above-referenced weight percentages are also possible (e.g., at least about 0 wt % and no more than about 15 wt % or at least about 2 wt % and no more than about 12 wt %), inclusive of all values and ranges therebetween. In some embodiments, the oil can make up about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt % of the first solution. In some embodiments, the oil can be organic. In some embodiments, the oil can include coconut oil, canola oil, flaxseed oil, sunflower oil, soybean oil, corn oil, cottonseed oil, olive oil, palm oil, peanut oil, safflower oil, sesame oil, almond oil, beech nut oil, Brazil nut oil, cashew oil, hazelnut oil, macadamia oil, mongongo nut oil, pecan oil, pine nut oil, pistachio oil, walnut oil, pumpkin seed oil, or any combination thereof.

In some embodiments, heat can be applied during or after the mixing of the first solution. In some embodiments, the heat can be applied via a hot plate, a heated stir tank, and/or providing a heated atmosphere in an enclosure. In some embodiments, the temperature increase can be used to dissolve powders and improve blending prior to fiber formation. This can be done by stirring the first solution in a mixing vessel while heating through a heat transfer plate. In some embodiments, the heating can be to a temperature of at least about 30° C., at least about 35° C., at least about 40° C., at least about 45° C., at least about 50° C., at least about 55° C., at least about 60° C., at least about 65° C., at least about 70° C., at least about 75° C., at least about 80° C., at least about 85° C., at least about 90° C., or at least about 95° C. In some embodiments, the heating can be to a temperature of no more than about 100° C., no more than about 95° C., no more than about C., no more than about 85° C., no more than about 80° C., no more than about 75° C., no more than about 70° C., no more than about 65° C., no more than about 60° C., no more than about 55° C., no more than about 50° C., no more than about 45° C., no more than about 40° C., or no more than about 30° C. Combinations of the above-referenced temperatures are also possible (e.g., at least about 30° C. and no more than about 100° C. or at least about 50° C. and no more than about 70° C.), inclusive of all values and ranges therebetween. In some embodiments, the heating can be to a temperature of about 30° C., about 35° C., about 40° C., about 45° C., about 50° C., about 55° C., about 60° C., about 65° C., about 70° C., about 75° C., about 80° C., about 85° C., about 90° C., about ° C., or about 100° C.

In some embodiments, the heating can be for a period of at least about 30 seconds, at least about 1 minute, at least about 5 minutes, at least about 10 minutes, at least about 30 minutes, at least about 1 hour, at least about 2 hours, at least about 4 hours, at least about 6 hours, at least about 8 hours, at least about 10 hours, at least about 12 hours, or at least about 18 hours. In some embodiments, the heating can be for a period of no more than about 24 hours, no more than about 18 hours, no more than about 12 hours, no more than about 10 hours, no more than about 8 hours, no more than about 6 hours, no more than about 4 hours, no more than about 2 hours, no more than about 1 hour, no more than about 30 minutes, no more than about 10 minutes, no more than about 5 minutes, or no more than about 1 minute. Combinations of the above-referenced time periods are also possible (e.g., at least about 30 seconds and no more than about 24 hours or at least about 1 hour and no more than about 10 hours), inclusive of all values and ranges therebetween. In some embodiments, the heating can be for a period of about 30 seconds, about 1 minute, about 5 minutes, about 10 minutes, about 30 minutes, about 1 hour, about 2 hours, about 4 hours, about 6 hours, about 8 hours, about 10 hours, about 12 hours, about 18 hours, or about 24 hours. In some embodiments, the first solution can be cooled (e.g., via a refrigerant).

Step 12 is optional and includes adding an acid and/or a base to the first solution. In some embodiments, the acid and/or base can be food safe. In some embodiments, the acid and/or base can be organic. In some embodiments, the acid can include acetic acid, carbonic acid, citric acid, ascorbic acid, fumaric acid, lactic acid, phosphoric acid, malic acid, tartaric acid, folic acid, hydrochloric acid, or any combination thereof. In some embodiments, the base can include sodium hydroxide, sodium bicarbonate, potassium bicarbonate, ammonium bicarbonate, or any combination thereof. In some embodiments, the acid and/or base can alter protein particle aggregation, dissolution, and molecular unfolding and conformation.

In some embodiments, the acid can be added to the first solution in such a proportion that the first solution includes at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 1.5 wt %, at least about 2 wt %, at least about 2.5 wt %, at least about 3 wt %, at least about 3.5 wt %, at least about 4 wt %, or at least about 4.5 wt % of the acid. In some embodiments, the acid can be added to the first solution in such a proportion that the first solution includes no more than about 5 wt %, no more than about 4.5 wt %, no more than about 4 wt %, no more than about 3.5 wt %, no more than about 3 wt %, no more than about 2.5 wt %, no more than about 2 wt %, no more than about 1.5 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, or no more than about 0.2 wt % of the acid. Combinations of the above-referenced weight percentages are also possible (e.g., at least about 0.1 wt % and no more than about 5 wt % or at least about 1 wt % and no more than about 3 wt %), inclusive of all values and ranges therebetween. In some embodiments, the acid can be added to the first solution in such a proportion that the first solution includes about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt %, about 2.5 wt %, about 3 wt %, about 3.5 wt %, about 4 wt %, about 4.5 wt %, or about 5 wt % of the acid.

In some embodiments, after the addition of the acid, the pH of the first solution can be at least about 2, at least about 2.5, at least about 3, at least about 3.5, at least about 4, at least about 4.5, at least about 5, at least about 5.5, at least about 6, at least about 6.5, at least about 7, at least about 7.5, at least about 8, at least about 8.5, at least about 9, or at least about 9.5. In some embodiments, after the addition of the acid, the pH of the first solution can be no more than about 10, no more than about 9.5, no more than about 9, no more than about 8.5, no more than about 8, no more than about 7.5, no more than about 7, no more than about 6.5, no more than about 6, no more than about 5.5, no more than about 5, no more than about 4.5, no more than about 4, no more than about 3.5, no more than about 3, or no more than about 2.5. Combinations of the above-referenced pH values are also possible (e.g., at least about 2 and no more than about 10 or at least about 3 and no more than about 6), inclusive of all values and ranges therebetween. In some embodiments, after the addition of the acid, the pH of the first solution can be about 2, about 2.5, about 3, about 3.5, about 4, about 4.5, about 5, about 5.5, about 6, about 6.5, about 7, about 7.5, about 8, about 8.5, about 9, or about 9.5, or about 10.

In some embodiments, the base can be added to the first solution in such a proportion that the first solution includes at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 1.5 wt %, at least about 2 wt %, at least about 2.5 wt %, at least about 3 wt %, at least about 3.5 wt %, at least about 4 wt %, or at least about 4.5 wt % of the base. In some embodiments, the base can be added to the first solution in such a proportion that the first solution includes no more than about 5 wt %, no more than about 4.5 wt %, no more than about 4 wt %, no more than about 3.5 wt %, no more than about 3 wt %, no more than about 2.5 wt %, no more than about 2 wt %, no more than about 1.5 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, or no more than about 0.2 wt % of the base. Combinations of the above-referenced weight percentages are also possible (e.g., at least about 0.1 wt % and no more than about 5 wt % or at least about 1 wt % and no more than about 3 wt %), inclusive of all values and ranges therebetween. In some embodiments, the base can be added to the first solution in such a proportion that the first solution includes about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt %, about 2.5 wt %, about 3 wt %, about 3.5 wt %, about 4 wt %, about 4.5 wt %, or about 5 wt % of the base.

In some embodiments, after the addition of the base, the pH of the first solution can be at least about 4, at least about 4.5, at least about 5, at least about 5.5, at least about 6, at least about 6.5, at least about 7, at least about 7.5, at least about 8, at least about 8.5, at least about 9, at least about 9.5, at least about 10, at least about 10.5, at least about 11, or at least about 11.5. In some embodiments, after the addition of the base, the pH of the first solution can be no more than about 12, no more than about 11.5, no more than about 11, no more than about 10.5, no more than about no more than about 9.5, no more than about 9, no more than about 8.5, no more than about 8, no more than about 7.5, no more than about 7, no more than about 6.5, no more than about 6, no more than about 5.5, no more than about 5, or no more than about 4.5. Combinations of the above-referenced pH values are also possible (e.g., at least about 4 and no more than about 12 or at least about 5 and no more than about 8), inclusive of all values and ranges therebetween. In some embodiments, after the addition of the base, the pH of the first solution can be about 4, about 4.5, about 5, about 5.5, about 6, about 6.5, about 7, about 7.5, about 8, about 8.5, about 9, about 9.5, about 10, about 10.5, about 11, or about 11.5, or about 12.

Step 13 includes causing ejection of a second solution. In some embodiments, the ejection of the second solution can be induced by rotating the first solution. In some embodiments, the second solution can be more concentrated than the first solution. In some embodiments, the second solution can have the same or a substantially similar concentration to the first solution. In some embodiments, the second solution can be the same or substantially similar to the first solution, but at a different part of the method 10 (i.e., during fiber formation). In some embodiments, the second solution can have different viscoelastic properties from the first solution. In some embodiments, the second solution can have a higher viscosity than the first solution. In some embodiments, the second solution can have a viscosity greater than a viscosity of the first solution by a factor of at least about 1.1, at least about 1.2, at least about 1.3, at least about 1.4, at least about 1.5, at least about 1.6, at least about 1.7, at least about 1.8, at least about 1.9, or at least about 2, inclusive of all values and ranges therebetween. In other words, the second solution can have a lower weight percentage of solvent than the first solution. In some embodiments, the ejection can be via extrusion. In some embodiments, the ejection can be via classic extrusion. In some embodiments, the extrusion can include single screw extrusion or twin-screw extrusion (either co-rotating or counter-rotating screws). In some embodiments, the ejection of the second solution can be by iRJS, electrospinning, blow spinning, solution blow spinning, wet spinning, jet spinning, or any combination thereof. In some embodiments, the diameters of the formed fibers can be controlled or affected by the iRJS spinneret properties, such as spinneret radius and diameter of orifices in spinneret wall. In some embodiments, the diameters of formed fibers can be controlled or affected by iRJS rotation rate. In some embodiments, the iRJS can operate under any of the parameters described in the '571 patent.

In some embodiments, the ejection of the second solution can be at a pressure of at least about 25 kPa (gauge), at least about 50 kPa, at least about 100 kPa, at least about 200 kPa, at least about 300 kPa, at least about 400 kPa, at least about 500 kPa, at least about 600 kPa, at least about 700 kPa, at least about 800 kPa, or at least about 900 kPa. In some embodiments, the ejection of the second solution can be at a pressure of no more than about 1,000 kPa, no more than about 900 kPa, no more than about 800 kPa, no more than about 700 kPa, no more than about 600 kPa, no more than about 500 kPa, no more than about 400 kPa, no more than about 300 kPa, no more than about 200 kPa, no more than about 100 kPa, or no more than about 50 kPa. Combinations of the above-referenced pressures are also possible (e.g., at least about 25 kPa and no more than about 1,000 kPa or at least about 300 kPa and no more than about 700 kPa), inclusive of all values and ranges therebetween. In some embodiments, the ejection of the second solution can be at a pressure of about 25 kPa, about 50 kPa, about 100 kPa, about 200 kPa, about 300 kPa, about 400 kPa, about 500 kPa, about 600 kPa, about 700 kPa, about 800 kPa, about 900 kPa, or about 1,000 kPa.

In some embodiments, the ejection of the second solution can be via a nozzle. In some embodiments, the nozzle can have a diameter of at least about 0.1 mm, at least about 0.2 mm, at least about 0.3 mm, at least about 0.4 mm, at least about 0.5 mm, at least about 0.6 mm, at least about 0.7 mm, at least about 0.8 mm, at least about 0.9 mm, at least about 1 mm, at least about 1.5 mm, at least about 2 mm, at least about 2.5 mm, at least about 3 mm, at least about 3.5 mm, at least about 4 mm, or at least about 4.5 mm. In some embodiments, the nozzle can have a diameter of no more than about 5 mm, no more than about 4.5 mm, no more than about 4 mm, no more than about 3.5 mm, no more than about 3 mm, no more than about 2.5 mm, no more than about 2 mm, no more than about 1.5 mm, no more than about 1 mm, no more than about 0.9 mm, no more than about 0.8 mm, no more than about 0.7 mm, no more than about 0.6 mm, no more than about 0.5 mm, no more than about 0.4 mm, no more than about 0.3 mm, or no more than about 0.2 mm. Combinations of the above-referenced nozzle diameters are also possible (e.g., at least about 0.1 mm and no more than about 5 mm or at least about 1 mm and no more than about 3 mm), inclusive of all values and ranges therebetween. In some embodiments, the nozzle can have a diameter of about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 1.5 mm, about 2 mm, about 2.5 mm, about 3 mm, about 3.5 mm, about 4 mm, about 4.5 mm, or about 5 mm.

Step 14 includes collecting the jet of the second solution in a precipitation bath. In some embodiments, the precipitation bath can surround an ejector apparatus, from which the second solution is ejected. The precipitation bath can be food safe. In some embodiments, the precipitation bath can be organic. In some embodiments, the precipitation bath can include water. In some embodiments, the precipitation bath can include coagulants and/or flocculants. In some embodiments, the precipitation bath can include salts or other additives to promote formation of fibers from the second solution. In some embodiments, the precipitation bath can include a vortex bath. In some embodiments, the solvent of the first solution can include water and ethanol, such that the collection of fibers forms in the precipitation bath via water-ethanol exchange. In some embodiments, the precipitation bath can include water with monovalent ions, divalent ions, salts of monovalent ions, salts of divalent ions, or any combination thereof. In some embodiments, the monovalent ions and/or divalent ions can be cations, anions, or mixtures thereof. In some embodiments, the salts can include calcium chloride, magnesium chloride, magnesium lactate. In some embodiments, the salts can include protons (or hydronium ions) or hydroxide ions that modulate pH. In some embodiments, the polysaccharides from the first solution and the second solution can undergo ionic gelation in the precipitation bath.

In some embodiments, the second solution can be acidic (e.g., having a pH of less than about 7, less than about 6.5, less than about 6, less than about 5.5, less than about 5, less than about 4.5, less than about 4, less than about 3.5, or less than about 3, inclusive of all values and ranges therebetween). In some embodiments, the second solution can be acidic and the precipitation bath can include a basic solution, such that the collection of fibers forms via acid/base exchange. In some embodiments, fiber gelation can occur from ion exchange. For example, polysaccharides such as alginate gel can gel via ion exchange. Additionally, sodium alginate spun into a vortex bath containing calcium can gel via sodium-calcium exchange. When polysaccharides interact with a precipitation bath containing calcium, ionic exchange can solidify and stabilize the fibers. This can occur via ionic gelation.

Step 15 is optional and includes heating the second solution. In some embodiments, the heating of the second solution can be after the second solution has been ejected into the precipitation bath. The heating can aid in killing germs in the second solution. In some embodiments, the heating can be at least partially concurrent with the ejection of the second solution into the precipitation bath. In other words, step 15 can be at least partially concurrent with step 14. In some embodiments, the second solution can be heated via a heat gun, or in a heated atmosphere or enclosure. In some embodiments, the second solution can be cooled (e.g., via a refrigerant).

In some embodiments, the heating can be to a temperature of at least about 30° C., at least about 35° C., at least about 40° C., at least about 45° C., at least about 50° C., at least about 55° C., at least about 60° C., at least about 65° C., at least about 70° C., at least about 75° C., at least about ° C., at least about 85° C., at least about 90° C., or at least about 95° C. In some embodiments, the heating can be to a temperature of no more than about 100° C., no more than about 95° C., no more than about 90° C., no more than about 85° C., no more than about 80° C., no more than about ° C., no more than about 70° C., no more than about 65° C., no more than about 60° C., no more than about 55° C., no more than about 50° C., no more than about 45° C., no more than about 40° C., or no more than about 30° C. Combinations of the above-referenced temperatures are also possible (e.g., at least about 30° C. and no more than about 100° C. or at least about 50° C. and no more than about 70° C.), inclusive of all values and ranges therebetween. In some embodiments, the heating can be to a temperature of about 30° C., about 35° C., about 40° C., about 45° C., about 50° C., about ° C., about 60° C., about 65° C., about 70° C., about 75° C., about 80° C., about 85° C., about 90° C., about 95° C., or about 100° C.

In some embodiments, the heating can be for a period of at least about 30 seconds, at least about 1 minute, at least about 5 minutes, at least about 10 minutes, at least about 30 minutes, at least about 1 hour, at least about 2 hours, at least about 4 hours, at least about 6 hours, at least about 8 hours, at least about 10 hours, at least about 12 hours, or at least about 18 hours. In some embodiments, the heating can be for a period of no more than about 24 hours, no more than about 18 hours, no more than about 12 hours, no more than about 10 hours, no more than about 8 hours, no more than about 6 hours, no more than about 4 hours, no more than about 2 hours, no more than about 1 hour, no more than about 30 minutes, no more than about 10 minutes, no more than about 5 minutes, or no more than about 1 minute. Combinations of the above-referenced time periods are also possible (e.g., at least about 30 seconds and no more than about 24 hours or at least about 1 hour and no more than about 10 hours), inclusive of all values and ranges therebetween. In some embodiments, the heating can be for a period of about 30 seconds, about 1 minute, about 5 minutes, about 10 minutes, about 30 minutes, about 1 hour, about 2 hours, about 4 hours, about 6 hours, about 8 hours, about 10 hours, about 12 hours, about 18 hours, or about 24 hours.

Step 16 is optional and includes drying the collection of fibers. Controlling the drying process can have significant impact on the structure of the resultant fibers, particularly the scaffold structure and the porosity of the fibers. In some embodiments, the drying can be at least partially concurrent with step 14 and/or step 15. In other words, the heating can be done during the drying process. In some embodiments, the drying can include pressing and/or spinning the collection of fibers. In some embodiments, the drying can be via a spin dryer. In some embodiments, the heating at step 15 can at least partially contribute to the drying of the collection of fibers. In some embodiments, the drying can be only partial, such that the collection of fibers is still surrounded by a stabilizing liquid after the drying.

Step 17 is optional and includes adding biological cells to the collection of fibers. In some embodiments, the biological cells can include mammalian cells, fish cells, avian cells, avian muscle myoblasts, mammalian muscle myoblasts, fish muscle myoblasts, fibroblasts, adipocytes, endothelial cells, epithelial cells, keratinocytes, stem cells, cells from crustaceans, cells from mollusks, or any combination thereof. In some embodiments, the biological cells can be anchorage-dependent. In other words, the biological cells can experience an increase in proliferation when they are allowed to attach to a solid surface. In some embodiments, the biological cells can be added to the collection of fibers in an amount such that the biological cells make up at least about 0.5 wt %, at least about 1 wt %, at least about 1.5 wt %, at least about 2 wt %, at least about 2.5 wt %, at least about 3 wt %, at least about 3.5 wt %, at least about 4 wt %, at least about 4.5 wt %, at least about 5 wt %, at least about 5.5 wt %, at least about 6 wt %, at least about 6.5 wt %, at least about 7 wt %, at least about 7.5 wt %, at least about 8 wt %, at least about 8.5 wt %, at least about 9 wt %, at least about 9.5 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt %, at least about 26 wt %, at least about 27 wt %, at least about 28 wt %, or at least about 29 wt %. of the collection of fibers. In some embodiments, the biological cells can be added to the collection of fibers in an amount such that the biological cells make up no more than about 30 wt %, no more than about 29 wt %, no more than about 28 wt %, no more than about 27 wt %, no more than about 26 wt %, no more than about 25 wt %, no more than about 24 wt %, no more than about 23 wt %, no more than about 22 wt %, no more than about 21 wt %, no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, no more than about 11 wt %, no more than about 10 wt %, no more than about 9.5 wt %, no more than about 9 wt %, no more than about 8.5 wt %, no more than about 8 wt %, no more than about 7.5 wt %, no more than about 7 wt %, no more than about 6.5 wt %, no more than about 6 wt %, no more than about 5.5 wt %, no more than about 5 wt %, no more than about 4.5 wt %, no more than about 4 wt %, no more than about 3.5 wt %, no more than about 3 wt %, no more than about 2.5 wt %, no more than about 2 wt %, no more than about 1.5 wt %, or no more than about 1 wt % of the collection of fibers.

Combinations of the above-referenced weight percentages are also possible (e.g., at least about 0.5 wt % and no more than about 30 wt % or at least about 2 wt % and no more than about 4 wt %), inclusive of all values and ranges therebetween. In some embodiments, the biological cells can be added to the collection of fibers in an amount such that the biological cells make up about wt %, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, or about 30 wt % of the collection of fibers.

Step 18 is optional and includes heating the collection of fibers. Heating can facilitate further drying the collection of fibers. The heating can also aid in killing microflora in the collection of fibers. In some embodiments, the heating can be in an oven. In some embodiments, the heating can be in a furnace. In some embodiments, the heating can be to a temperature of at least about 100° C., at least about 110° C., at least about 120° C., at least about 130° C., at least about 140° C., at least about 150° C., at least about 160° C., at least about 170° C., at least about 180° C., at least about 190° C., at least about 200° C., at least about 210° C., at least about 220° C., at least about 230° C., at least about 240° C., at least about 250° C., at least about 260° C., at least about 270° C., at least about 280° C., or at least about 290° C. In some embodiments, the heating can be to a temperature of no more than about 300° C., no more than about 290° C., no more than about 280° C., no more than about 270° C., no more than about 260° C., no more than about 250° C., no more than about 240° C., no more than about 230° C., no more than about 220° C., no more than about 210° C., no more than about 200° C., no more than about 190° C., no more than about 180° C., no more than about 170° C., no more than about 160° C., no more than about 150° C., no more than about 140° C., no more than about 130° C., no more than about 120° C., or no more than about 110° C. Combinations of the above-referenced temperatures are also possible (e.g., at least about 100° C. and no more than about 300° C. or at least about 150° C. and no more than about 250° C.), inclusive of all values and ranges therebetween. In some embodiments, the heating can be to a temperature of about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., about 250° C., about 260° C., about 270° C., about 280° C., about 290° C., or about 300° C.

In some embodiments, the heating can be for a time period of at least about 15 minutes, at least about 30 minutes, at least about 1 hour, at least about 2 hours, at least about 4 hours, at least about 6 hours, at least about 8 hours, at least about 10 hours, at least about 12 hours, or at least about 18 hours. In some embodiments, the heating can be for a time period of no more than about 24 hours, no more than about 18 hours, no more than about 12 hours, no more than about 10 hours, no more than about 8 hours, no more than about 6 hours, no more than about 4 hours, no more than about 2 hours, no more than about 1 hour, or no more than about 30 minutes. Combinations of the above-referenced time periods are also possible (e.g., at least about 15 minutes and no more than about 24 hours or at least about 4 hours and no more than about 8 hours), inclusive of all values and ranges therebetween. In some embodiments, the heating can be for a time period of about 15 minutes, about 30 minutes, about 1 hour, about 2 hours, about 4 hours, about 6 hours, about 8 hours, about 10 hours, about 12 hours, or about 18 hours. In some embodiments, the collection of fibers can be cooled (e.g., via a refrigerant).

Step 19 is optional and includes adding a salt, a thiol, and/or mercaptoethanol to the collection of fibers. The salt, thiol, and/or mercaptoethanol can cleave disulphide bonds in the collection of fibers, leading to disulphide bond cleavage and opening of protein tertiary structure. In some embodiments, the cleaving can be done at a pH of at least about 7, at least about 7.5, at least about 8, at least about 8.5, at least about 9, at least about 9.5, at least about 10, at least about 10.5, or at least about 11, inclusive of all values and ranges therebetween.

Step 20 includes pulling apart the collection of fibers and adding fat and flavoring to the collection of fibers to form the fibrous food product. In some embodiments, pulling apart the collection of fibers can occur at least partially concurrently with the addition of fat and flavoring to the collection of fibers. In some embodiments, pulling the fibers apart can be automatic. In some embodiments, pulling apart the collection of fibers can occur at a different time from the addition of fat and flavoring to the collection of fibers. In some embodiments, the fibers can be pulled apart manually. In some embodiments, the fibers can be pulled apart by a machine. In some embodiments, the fibers can be pulled apart by hand. Pulling apart the collection of fibers can effectively separate the collection of fibers into a plurality of “sub-bundles” of fibers. The sub-bundles of fibers have larger surface area-to-volume ratios than the original bundles of fibers, such that the fat added to the fibers can diffuse deeper and more thoroughly into the collection of fibers.

In some embodiments, the fat added to the fibers at step 20 can include an oil. In some embodiments, the oil can be food safe. In some embodiments, the oil can be organic. In some embodiments, the oil can include coconut oil, canola oil, flaxseed oil, sunflower oil, soybean oil, corn oil, cottonseed oil, olive oil, palm oil, peanut oil, safflower oil, sesame oil, almond oil, beech nut oil, Brazil nut oil, cashew oil, hazelnut oil, macadamia oil, mongongo nut oil, pecan oil, pine nut oil, pistachio oil, walnut oil, pumpkin seed oil, or any combination thereof. In some embodiments, the collection of fibers can be at least partially immersed in a stabilizing liquid. In some embodiments, the oil can be partitioned between the fibers and a stabilizing liquid. In some embodiments, the flavoring can include one or more salts. In some embodiments, the flavoring can include a flavor enhancer. In some embodiments, the flavoring can include an aroma enhancer. In some embodiments, a color enhancer can be added to the collection of fibers at step 20. In some embodiments, the flavoring can include one or more spices. In some embodiments, the flavoring can include table salt, black pepper, paprika, oregano, anise, celery seed, cassia, catnip, cardamom, caraway, burnet, brown mustard, borage, black pepper, mustard seeds, cumin, bergamot, basil, bay leaf, asafoetida, anise, angelica, allspice, cayenne pepper, chervil, chicory, chili pepper, cinnamon, cilantro, clove, coriander, costmary, curry, dill, fennel, fenugreek, file, ginger, grains of paradise, holy basil, horehound, horseradish, hyssop, lavender, lemon balm, lemon grass, lemon verbena, licorice, lovage, mace, marjoram, nutmeg, oregano, paprika, parsley, peppermint, poppy seed, rosemary, rue, saffron, sage, savory, sesame, sorrel, star anise, spearmint, tarragon, thyme, turmeric, vanilla, wasabi, or any combination thereof.

In some embodiments, the fibers in the fibrous food product can be at least partially non-woven. A non-woven fiber structure can enable the fibers to entangle in a random or disordered pattern and hold together similar to whole-muscle meat products and subsequently shred. This can prevent the fibers from falling apart or from being easily torn apart.

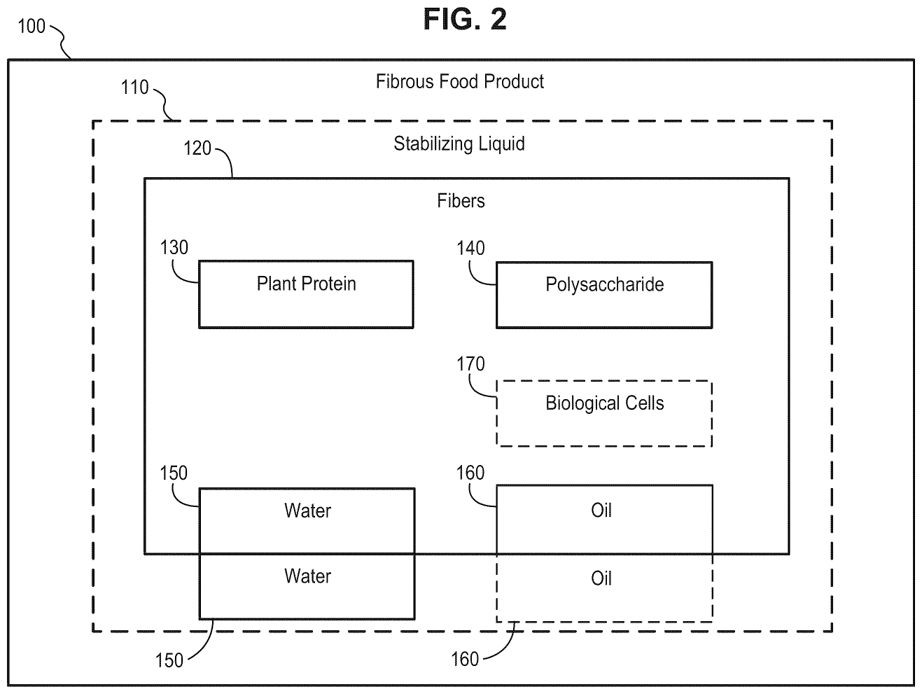

FIG. 2 is a block diagram of a fibrous food product 100, according to an embodiment. As shown, the fibrous food product 100 can include a stabilizing liquid 110 (including water 150) with fibers 120 dispersed therein. The fibers 120 include a plant protein 130, a polysaccharide 140, water 150, and oil 160. In some embodiments, the oil 160 can be partitioned between the fibers 120 and the stabilizing liquid 110, such that the oil 160 is in both portions. In some embodiments, the fibers 120 can include biological cells 170 disposed therein.

The stabilizing liquid 110 includes water 150. In some embodiments, the stabilizing liquid 110 can include alcohol, additives, acids, bases, salts, flavorings, spices, coagulants, flocculants, or any combinations thereof. In some embodiments, the stabilizing liquid 110 can include calcium. In some embodiments, the stabilizing liquid 110 can make up at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, or at least about 19 wt % of the fibrous food product 100. In some embodiments, the stabilizing liquid 110 can make up no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, no more than about 6 wt %, no more than about 5 wt %, no more than about 4 wt %, no more than about 3 wt %, or no more than about 2 wt % of the fibrous food product 100. Combinations of the above-referenced weight percentages are also possible (e.g., at least about 1 wt % and no more than about 20 wt % or at least about 5 wt % and no more than about 15 wt %), inclusive of all values and ranges therebetween. In some embodiments, the stabilizing liquid 110 can make up about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, or about 20 wt % of the fibrous food product 100.

In some embodiments, the flavoring can include a flavor enhancer. In some embodiments, the flavoring can include an aroma enhancer. In some embodiments, the fibrous food product 100 can include an aroma enhancer, a color enhancer, a flavor enhancer, or any combination thereof. In some embodiments, the aroma enhancer, the color enhancer, and the flavor enhancer can combine to make up less than about 15 wt %, less than about 14 wt %, less than about 13 wt %, less than about 12 wt %, less than about 11 wt %, less than about 10 wt %, less than about 9 wt %, less than about 8 wt %, less than about 7 wt %, less than about 6 wt %, less than about 5 wt %, less than about 4 wt %, less than about 3 wt %, less than about 2 wt %, or less than about 1 wt % of the fibers 120, inclusive of all values and ranges therebetween. In some embodiments, the fibrous food product 100 can be free of any cells originating from a living animal.

As shown, the fibers 120 include the plant protein 130, the polysaccharide 140, water 150, oil 160, and optionally biological cells 170. In some embodiments, the fibers 120 can include dietary fiber, insoluble fiber, soluble fiber, prebiotic fiber, fermentable fiber, viscous fiber, resistant starch, or any combination thereof.

In some embodiments, the fibers 120 can have a thickness of at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 110 μm, at least about 120 μm, at least about 130 μm, at least about 140 μm, at least about 150 μm, at least about 160 μm, at least about 170 μm, at least about 180 μm, or at least about 190 μm. In some embodiments, the fibers 120 can have a thickness of no more than about 200 μm, no more than about 190 μm, no more than about 180 μm, no more than about 170 μm, no more than about 160 μm, no more than about 150 μm, no more than about 140 μm, no more than about 130 μm, no more than about 120 μm, no more than about 110 μm, no more than about 100 μm, no more than about 90 μm, no more than about 80 μm, no more than about 70 μm, no more than about μm, no more than about 50 μm, no more than about 40 μm, no more than about 30 μm, or no more than about 20 μm. Combinations of the above-referenced fiber thicknesses are also possible (e.g., at least about 10 μm and no more than about 200 μm or at least about 50 μm and no more than about 100 μm), inclusive of all values and ranges therebetween. In some embodiments, the fibers 120 can have a thickness of about 10 μm, about 20 μm, about 30 μm, about 40 μm, about about 60 μm, about 70 μm, about 80 μm, about 90 μm, about 100 μm, about 110 μm, about 120 μm, about 130 μm, about 140 μm, about 150 μm, about 160 μm, about 170 μm, about 180 μm, about 190 μm, or about 200 μm.

In some embodiments, the fibers 120 can have lengths of at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 10 cm, at least about 15 cm, at least about 20 cm, or at least about 25 cm. In some embodiments, the fibers 120 can have lengths of no more than about 30 cm, no more than about 25 cm, no more than about 20 cm, no more than about 15 cm, no more than about 10 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced lengths of the fibers 120 are also possible (e.g., at least about 1 mm and no more than about 30 cm or at least about 5 mm and no more than about 10 cm), inclusive of all values and ranges therebetween. In some embodiments, the fibers 120 can have lengths of about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 10 cm, about 15 cm, about 20 cm, about 25 cm, or about 30 cm.

In some embodiments, the fibers 120 can make up at least about 80 wt %, at least about 81 wt %, at least about 82 wt %, at least about 83 wt %, at least about 84 wt %, at least about 85 wt %, at least about 86 wt %, at least about 87 wt %, at least about 88 wt %, at least about 89 wt %, at least about 90 wt %, at least about 91 wt %, at least about 92 wt %, at least about 93 wt %, at least about 94 wt %, at least about 95 wt %, at least about 96 wt %, at least about 97 wt %, at least about 98 wt %, or at least about 99 wt % of the fibrous food product 100. In some embodiments, the fibers 120 can make up no more than about 100 wt %, no more than about 99 wt %, no more than about 98 wt %, no more than about 97 wt %, no more than about 96 wt %, no more than about 95 wt %, no more than about 94 wt %, no more than about 93 wt %, no more than about 92 wt %, no more than about 91 wt %, no more than about 90 wt %, no more than about 89 wt %, no more than about 88 wt %, no more than about 87 wt %, no more than about 86 wt %, no more than about 85 wt %, no more than about 84 wt %, no more than about 83 wt %, no more than about 82 wt %, or no more than about 81 wt % of the fibrous food product 100. Combinations of the above-referenced weight percentages are also possible (e.g., at least about 80 wt % and no more than about 100 wt % or at least about 85 wt % and no more than about 95 wt %), inclusive of all values and ranges therebetween. In some embodiments, the fibers 120 can make up about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, about 97 wt %, about 98 wt %, about 99 wt %, or about 100 wt % of the fibrous food product 100.

In some embodiments, the fibers 120 can include ions. In some embodiments, the ions can include sodium ions, calcium ions, magnesium ions, or any combination thereof. In some embodiments, the fibers 120 can include macromolecules. In some embodiments, the ions and/or the macromolecules can make up about 0.5 wt %, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the fibers 120, inclusive of all values and ranges therebetween. In some embodiments, the fibers 120 can be at least partially non-woven. In other words, the fibers 120 can become entangled and provide resistance to being torn apart.

The plant protein 130 is included in the fibers 120. In some embodiments, the plant protein 130 can include proteins derived from rice, peas, soy, barley, rice, barley rice, beans, fava beans, seitan, tempeh, edamame, lentils, chickpeas, nutritional yeast, spelt, teff, seeds, hemp seeds, amaranth, quinoa, spirulina, green peas, oats, Ezekiel bread, wild rice, nuts, chia seeds, mycoprotein, or any combination thereof. In some embodiments, the plant protein 130 can include one or more amino acids. In some embodiments, the plant protein 130 can include alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine, or any combination thereof.

In some embodiments, the plant protein 130 can make up at least about 5 wt %, at least about 10 wt %, at least about 15 wt %, at least about 20 wt %, at least about 25 wt %, at least about wt %, at least about 35 wt %, at least about 40 wt %, at least about 45 wt %, at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about wt %, at least about 96 wt %, at least about 97 wt %, at least about 98 wt %, or at least about 99 wt % of the fibers 120. In some embodiments, the plant protein 130 can make up no more than about 100 wt %, no more than about 99 wt %, no more than about 98 wt %, no more than about 97 wt %, no more than about 96 wt %, no more than about 95 wt %, no more than about 90 wt %, no more than about 85 wt %, no more than about 80 wt %, no more than about 75 wt %, no more than about 70 wt %, no more than about 65 wt %, no more than about 60 wt %, no more than about 55 wt %, no more than about 50 wt %, no more than about 45 wt %, no more than about 40 wt %, no more than about 35 wt %, no more than about 30 wt %, no more than about 25 wt %, no more than about 20 wt %, no more than about 15 wt %, or no more than about 10 wt % of the fibers 120. Combinations of the above-referenced weight percentages are also possible (e.g., at least about 5 wt % and no more than about 100 wt % or at least about 70 wt % and no more than about 90 wt %), inclusive of all values and ranges therebetween. In some embodiments, the plant protein 130 can make up about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, about 98 wt %, about 99 wt %, or about 100 wt % of the fibers 120.

The polysaccharide 140 is also included in the fibers 120. In some embodiments, the polysaccharide can include cellulose, starch, glycogen, sucrose, dextrin, hemicellulose, polydextrose, inulin, glucans, beta-glucan, pectin, psyllium husk mucilage, galactomannans, gums, beta-mannan, carob, fenugreek, guar gum, tara gum, methylcellulose, glucomannan gum, konjac gum, gum acacia, karaya gum, pullulan, tragacanth gum, arabinoxylan gum, xanthan gum, agar, alginate, carrageenan, chitin, chitosan, trehalose, or any combination thereof.

In some embodiments, the polysaccharide 140 can make up at least about 0.25 wt %, at least about 0.5 wt %, at least about 0.75 wt %, at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt %, at least about 26 wt %, at least about 27 wt %, at least about 28 wt %, at least about 29 wt %, at least about 30 wt %, at least about 31 wt %, at least about 32 wt %, at least about 33 wt %, at least about 34 wt %, at least about 35 wt %, at least about 36 wt %, at least about 37 wt %, at least about 38 wt %, or at least about 39 wt % of the fibers 120. In some embodiments, the polysaccharide 140 can make up no more than about 40 wt %, no more than about 39 wt %, no more than about 38 wt %, no more than about 37 wt %, no more than about 36 wt %, no more than about wt %, no more than about 34 wt %, no more than about 33 wt %, no more than about 32 wt %, no more than about 31 wt %, no more than about 30 wt %, no more than about 29 wt %, no more than about 28 wt %, no more than about 27 wt %, no more than about 26 wt %, no more than about 25 wt %, no more than about 24 wt %, no more than about 23 wt %, no more than about 22 wt %, no more than about 21 wt %, no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.75 wt %, or no more than about 0.5 wt % of the fibers 120. Combinations of the above-referenced weight percentages are also possible (e.g., at least about wt % and no more than about 40 wt % or at least about 5 wt % and no more than about 15 wt %), inclusive of all values and ranges therebetween. In some embodiments, the polysaccharide 140 can make up about 0.25 wt %, about 0.5 wt %, about 0.75 wt %, about 1 wt %, about 2 wt %, about 3 wt %, about 4 wt %, about 5 wt %, about 6 wt %, about 7 wt %, about 8 wt %, about 9 wt %, about wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, or about 40 wt % of the fibers 120.

The water 150 is included in the fibers 120. In some embodiments, the water 150 can be partitioned between the stabilizing liquid 110 and the fibers 120. The oil 160 is included in the fibers 120. In some embodiments, the oil 160 can be partitioned between the fibers 120 and the stabilizing liquid 110. In some embodiments, the oil 160 can make up at least about 1 wt %, at least about 1.5 wt %, at least about 2 wt %, at least about 2.5 wt %, at least about 3 wt %, at least about 3.5 wt %, at least about 4 wt %, at least about 4.5 wt %, at least about 5 wt %, at least about wt %, at least about 6 wt %, at least about 7.5 wt %, at least about 8 wt %, at least about 8.5 wt %, at least about 9 wt %, at least about 9.5 wt %, at least about 10 wt %, at least about 15 wt %, at least about 20 wt %, at least about 25 wt %, at least about 30 wt %, at least about 35 wt %, at least about wt %, at least about 45 wt %, at least about 50 wt %, or at least about 55 wt % of the fibers 120. In some embodiments, the oil 160 can make up no more than about 60 wt %, no more than about wt %, no more than about 50 wt %, no more than about 45 wt %, no more than about 40 wt %, no more than about 35 wt %, no more than about 30 wt %, no more than about 25 wt %, no more than about 20 wt %, no more than about 15 wt %, no more than about 10 wt %, no more than about 9.5 wt %, no more than about 9 wt %, no more than about 8.5 wt %, no more than about 8 wt %, no more than about 7.5 wt %, no more than about 7 wt %, no more than about 6.5 wt %, no more than about 6 wt %, no more than about 5.5 wt %, no more than about 5 wt %, no more than about 4.5 wt %, no more than about 4 wt %, no more than about 3.5 wt %, no more than about 3 wt %, no more than about 2.5 wt %, no more than about 2 wt %, or no more than about 1.5 wt %. Combinations of the above-referenced weight percentages are also possible (e.g., at least about 1 wt % and no more than about 60 wt % or at least about 3 wt % and no more than about 8 wt %), inclusive of all values and ranges therebetween. In some embodiments, the oil 160 can make up about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 7.5 wt %, about 8 wt %, about 8.5 wt %, about 9 wt %, about 9.5 wt %, about 10 wt %, about 15 wt %, about 20 wt %, about 25 wt %, about 30 wt %, about wt %, about 40 wt %, about 45 wt %, about 50 wt %, about 55 wt %, or about 60 wt % of the fibers 120.

In some embodiments, the biological cells 170 can include mammalian cells, fish cells, avian cells, avian muscle myoblasts, mammalian muscle myoblasts, fish muscle myoblasts, fibroblasts, adipocytes, endothelial cells, epithelial cells, keratinocytes, stem cells, cells from crustaceans, cells from mollusks, or any combination thereof. In some embodiments, the biological cells 170 can make up about 0.5 wt %, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the fibers 120, inclusive of all values and ranges therebetween.

In some embodiments, the fibrous food product 100 can be heart healthy, in accordance with the “heart healthy” definition provided by the Food and Drug Administration (FDA) pursuant to 21 CFR § 101 (Volume 2). In other words, the fibrous food product 100 can be certified with the American Heart Association's (AHA) heart-check mark. For example, the fibrous food product 100 can include less than 6.5 g of fat, less than 1 g of saturated fat (or less than 15% of its calories can be from saturated fat), less than 0.5 g of trans fat, less than 20 mg of cholesterol, less than 20 mg of sodium, and at least 10% of the daily value of at least one of vitamin A, vitamin C, iron, calcium, protein, or dietary fiber per serving (e.g., 50 g).

In some embodiments, the fibrous food product 100 can have a hardness value of at least about 2 N, at least about 2.1 N, at least about 2.2 N, at least about 2.3 N, at least about 2.4 N, at least about 2.5 N, at least about 2.6 N, at least about 2.7 N, at least about 2.8 N, at least about 2.9 N, at least about 3 N, at least about 3.1 N, at least about 3.2 N, at least about 3.3 N, at least about 3.4 N, at least about 3.5 N, at least about 3.6 N, at least about 3.7 N, at least about 3.8 N, or at least about 3.9 N on the textural properties of food scale. In some embodiments, the fibrous food product 100 can have a hardness value of no more than about 4 N, no more than about 3.9 N, no more than about 3.8 N, no more than about 3.7 N, no more than about 3.6 N, no more than about 3.5 N, no more than about 3.4 N, no more than about 3.3 N, no more than about 3.2 N, no more than about 3.1 N, no more than about 3 N, no more than about 2.9 N, no more than about 2.8 N, no more than about 2.7 N, no more than about 2.6 N, no more than about 2.5 N, no more than about 2.4 N, no more than about 2.3 N, no more than about 2.2 N, or no more than about 2.1 N. Combinations of the above-referenced hardness values are also possible (e.g., at least about 2 N and no more than about 4 N or at least about 2.3 N and no more than about 3.5 N), inclusive of all values and ranges therebetween. In some embodiments, the fibrous food product 100 can have a hardness value of about 2 N, about 2.1 N, about 2.2 N, about 2.3 N, about 2.4 N, about 2.5 N, about 2.6 N, about 2.7 N, about 2.8 N, about 2.9 N, about 3 N, about 3.1 N, about 3.2 N, about 3.3 N, about 3.4 N, about 3.5 N, about 3.6 N, about 3.7 N, about 3.8 N, about 3.9 N, or about 4 N.

In some embodiments, the fibrous food product 100 can have a springiness value of at least about 6 N, at least about 6.1 N, at least about 6.2 N, at least about 6.3 N, at least about 6.4 N, at least about 6.5 N, at least about 6.6 N, at least about 6.7 N, at least about 6.8 N, or at least about 6.9 N on the textural properties of food scale. In some embodiments, the fibrous food product 100 can have a springiness value of no more than about 7 N, no more than about 6.9 N, no more than about 6.8 N, no more than about 6.7 N, no more than about 6.6 N, no more than about 6.5 N, no more than about 6.4 N, no more than about 6.3 N, no more than about 6.2 N, or no more than about 6.1 N. Combinations of the above-referenced springiness values are also possible (e.g., at least about 6 N and no more than about 7 N or at least about 6.1 N and no more than about 6.9 N), inclusive of all values and ranges therebetween. In some embodiments, the fibrous food product 100 can have a springiness value of about 6 N, about 6.1 N, about 6.2 N, about 6.3 N, about 6.4 N, about 6.5 N, about 6.6 N, about 6.7 N, about 6.8 N, about 6.9 N, or about 7 N.

In some embodiments, the fibrous food product 100 can have a cohesiveness value of at least about 0.4, at least about 0.41, at least about 0.42, at least about 0.43, at least about 0.44, at least about 0.45, at least about 0.46, at least about 0.47, at least about 0.48, at least about 0.49, at least about 0.5, at least about 0.51, at least about 0.52, at least about 0.53, at least about 0.54, at least about 0.55, at least about 0.56, at least about 0.57, at least about 0.58, or at least about 0.59 on the textural properties food scale. In some embodiments, the fibrous food product can have a cohesiveness value of no more than about 0.6, no more than about 0.59, no more than about 0.58, no more than about 0.57, no more than about 0.56, no more than about 0.55, no more than about no more than about 0.53, no more than about 0.52, no more than about 0.51, no more than about 0.5, no more than about 0.49, no more than about 0.48, no more than about 0.47, no more than about 0.46, no more than about 0.45, no more than about 0.44, no more than about 0.43, no more than about 0.42, or no more than about 0.41. Combinations of the above-referenced cohesiveness values are also possible (e.g., at least about 0.4 and no more than about 0.6 or at least about 0.45 and no more than about 0.55), inclusive of all values and ranges therebetween. In some embodiments, the fibrous food product 100 can have a cohesiveness value of about 0.4, about 0.41, about 0.42, about 0.43, about 0.44, about 0.45, about 0.46, about 0.47, about 0.48, about 0.49, about 0.5, about 0.51, about 0.52, about 0.53, about 0.54, about 0.55, about 0.56, about 0.57, about about 0.59, or about 0.6.

In some embodiments, the fibrous food product 100 can have a gumminess value of at least about 1, at least about 1.1, at least about 1.2, at least about 1.3, at least about 1.4, at least about 1.5, at least about 1.6, at least about 1.7, at least about 1.8, or at least about 1.9 on the textural properties of food scale. In some embodiments, the fibrous food product 100 can have a gumminess value of no more than about 2, no more than about 1.9, no more than about 1.8, no more than about 1.7, no more than about 1.6, no more than about 1.5, no more than about 1.4, no more than about 1.3, no more than about 1.2, or no more than about 1.1. Combinations of the above-referenced gumminess values are also possible (e.g., at least about 1 and no more than about 2 or at least about 1.1 and no more than about 1.9), inclusive of all values and ranges therebetween. In some embodiments, the fibrous food product 100 can have a gumminess value of about 1, about 1.1, about 1.2, about 1.3, about 1.4, about 1.5, about 1.6, about 1.7, about 1.8, about 1.9, or about 2.

In some embodiments, the fibrous food product 100 can have a chewiness value of at least about 0.5, at least about 0.6, at least about 0.7, at least about 0.8, at least about 0.9, at least about 1, at least about 1.1, at least about 1.2, at least about 1.3, or at least about 1.4 on the textural properties of food scale. In some embodiments, the fibrous food product 100 can have a chewiness value of no more than about 1.5, no more than about 1.4, no more than about 1.3, no more than about 1.2, no more than about 1.1, no more than about 1, no more than about 0.9, no more than about 0.8, no more than about 0.7, or no more than about 0.6. Combinations of the above-referenced chewiness values are also possible (e.g., at least about 0.5 and no more than about 1.5 or at least about 0.6 and no more than about 1.3), inclusive of all values and ranges therebetween. In some embodiments, the fibrous food product 100 can have a chewiness value of about 0.5, about 0.6, about 0.7, about 0.8, about 0.9, about 1, about 1.1, about 1.2, about 1.3, about 1.4, or about 1.5.

In some embodiments, the fibrous food product 100 can have a Warner-Bratzler shear strength of at least about 0.25 kg, at least about 0.5 kg, at least about 1 kg, at least about 1.5 kg, at least about 2 kg, at least about 2.5 kg, at least about 3 kg, at least about 3.5 kg, at least about 4 kg, at least about 4.5 kg, at least about 5 kg, or at least about 5.5 kg. In some embodiments, the fibrous food product 100 can have a Warner-Bratzler shear strength of no more than about 6 kg, no more than about 5.5 kg, no more than about 5 kg, no more than about 4.5 kg, no more than about 4 kg, no more than about 3.5 kg, no more than about 3 kg, no more than about 2.5 kg, no more than about 2 kg, no more than about 1.5 kg, no more than about 1 kg, or no more than about 0.5 kg. Combinations of the above-referenced Warner-Bratzler shear strengths are also possible (e.g., at least about 0.25 kg and no more than about 6 kg or at least about 0.5 kg and no more than about 5 kg), inclusive of all values and ranges therebetween. In some embodiments, the fibrous food product 100 can have a Warner-Bratzler shear strength of about 0.25 kg, about 0.5 kg, about 1 kg, about 1.5 kg, about 2 kg, about 2.5 kg, about 3 kg, about 3.5 kg, about 4 kg, about 4.5 kg, about 5 kg, about 5.5 kg, or about 6 kg.

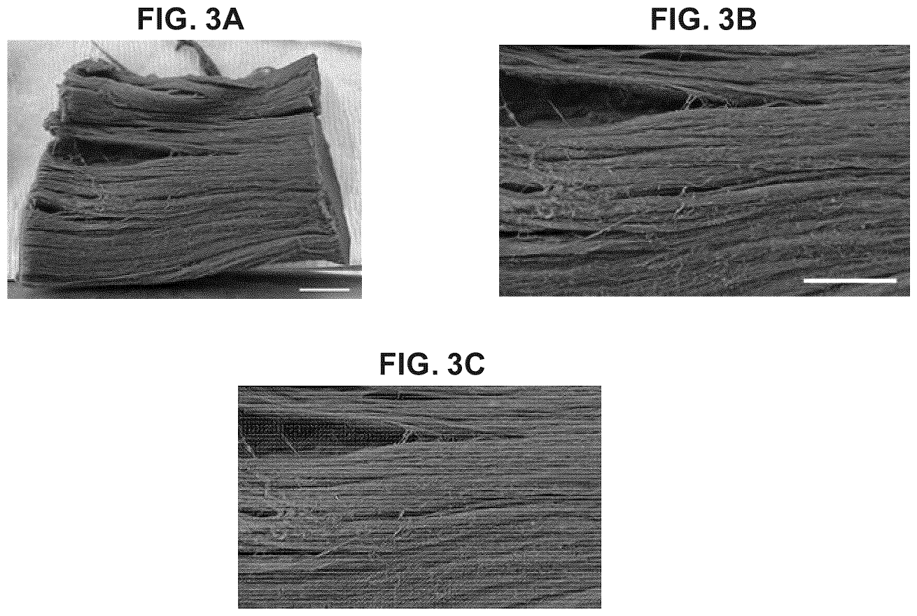

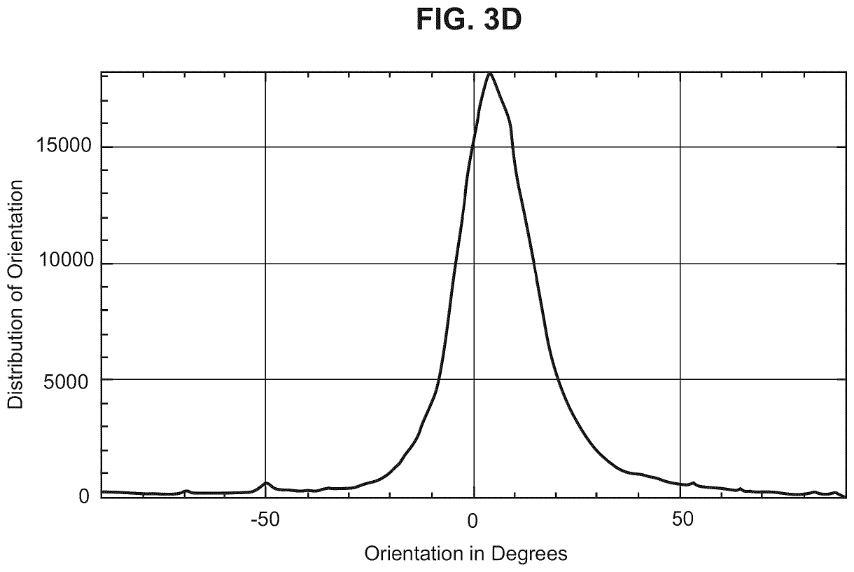

FIGS. 3A-3D show a fibrous scaffolding with highly aligned, densely packed, individual plant-based fibers, and orientation data associated therewith. The fibrous scaffolding was formed by mixing 7 parts (by mass) plant protein with 2 parts polysaccharide and 1 part red-brown coloring agent in watter to form a dispersion that was ejected via rotary spinning.

FIG. 3A shows a section of the fibrous scaffold with a 1 cm scale bar. FIG. 3B shows a cropped section of FIG. 3A used for directionality analysis via the OrientationJ plugin for ImageJ software. The scale bar in FIG. 3B is 1 cm. FIG. 3C shows a vector field overlayed on the image shown in FIG. 3B. FIG. 3D shows the distribution of fiber orientation in the fibrous scaffold. As shown, the fiber orientation is highly localized to 0 degrees, indicating a high degree of fiber alignment.

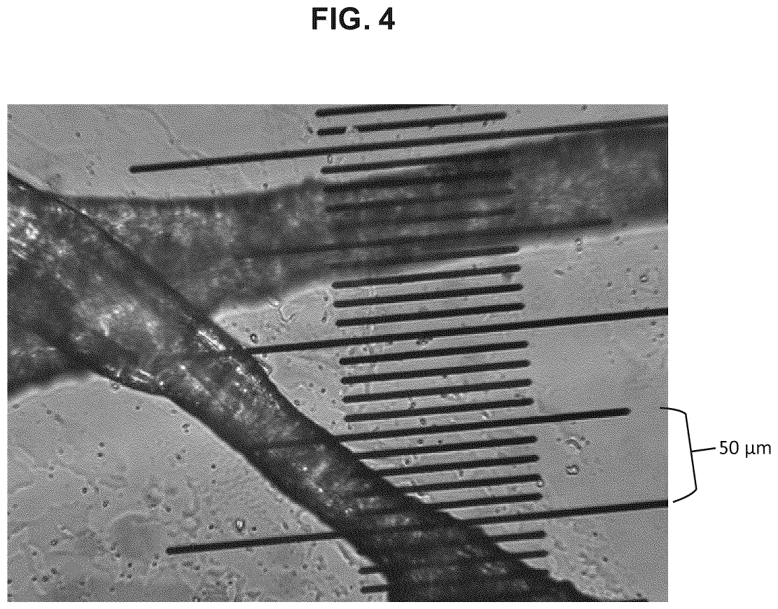

FIG. 4 shows a microscopic view of a plant-based fiber. The plant-based fiber was formed by mixing 7 parts plant protein with 3 parts polysaccharide in water to form a dispersion that was then ejected via rotary jet spinning. As shown, the distance between the short black lines on the scale are 10 μm. The plant-based fiber has a variable thickness between about 30 μm and about 50 μm.

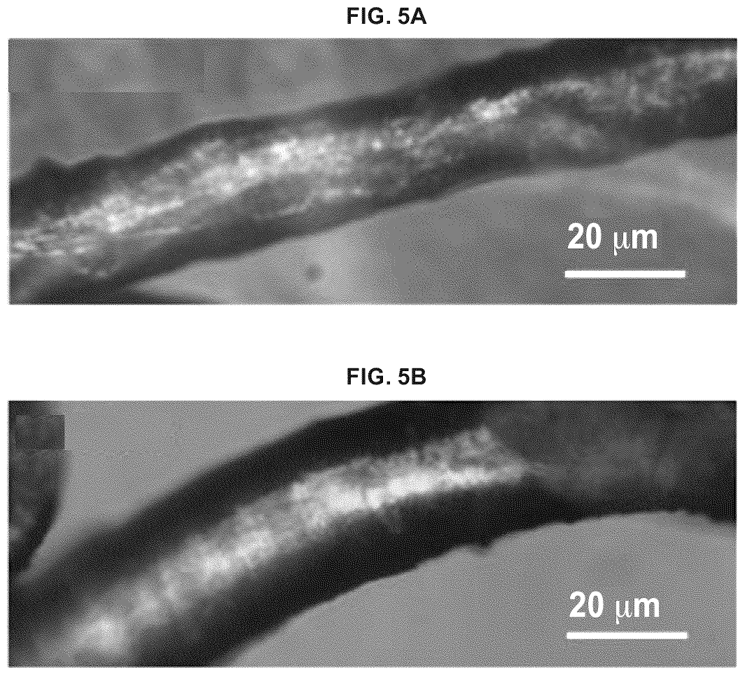

FIGS. 5A-5B show a comparison of microscopic views of a plant-based fiber (formed via the same process described with respect to FIG. 4) and a pork fiber. FIG. 5A shows a plant-based fiber, while FIG. 5B shows a pork fiber. Scale bars of 20 μm are shown for scale. As shown, the plant-based fiber has a similar diameter and appearance, with only a minimal difference in texture, as compared to the pork fiber.

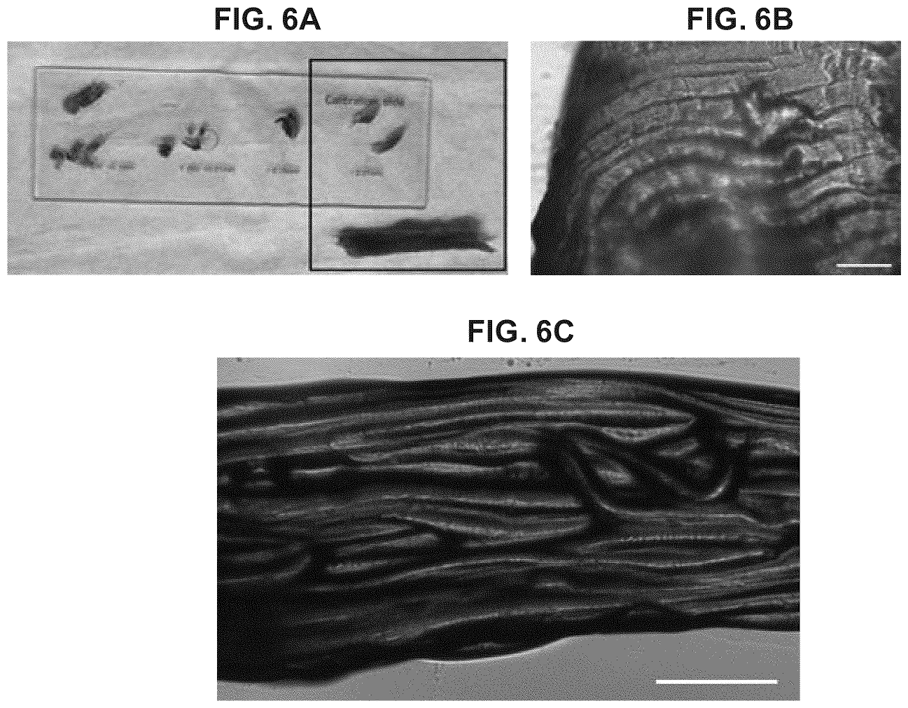

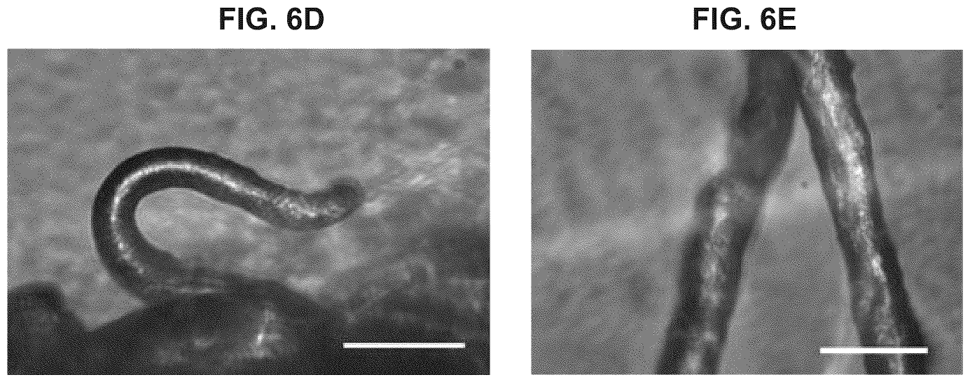

FIGS. 6A-6E show a comparison of raw beef steak fibers and plant-based fibers. FIG. 6A shows a microscope slide containing small sections of raw beef steak and plant-based collections of fibers formed via iRJS. Plant-based iRJS fibers are shown inside the black box, while beef steak specimens are outside of the black box. Plant-based iRJS samples were colored with food dye and are nearly indistinguishable from raw beef. FIG. 6B shows a section of a steak tissue with densely packed muscle fibers. The scale bar in FIG. 6B is 100 μm. FIG. 6C shows a bundle of plant-based fibers produced via iRJS. The scale bar in FIG. 6C is 200 μm. FIG. 6D shows an individual curled muscle fiber emerging from a raw beef steak tissue. The scale bar in FIG. 6D is 50 μm. FIG. 6E shows individual fibers produced via iRJS. The scale bar in FIG. 6E is 50 μm. As shown, the plant-based fibers are virtually indistinguishable from the raw beef muscle fibers at both a macro level and a microscopic level.

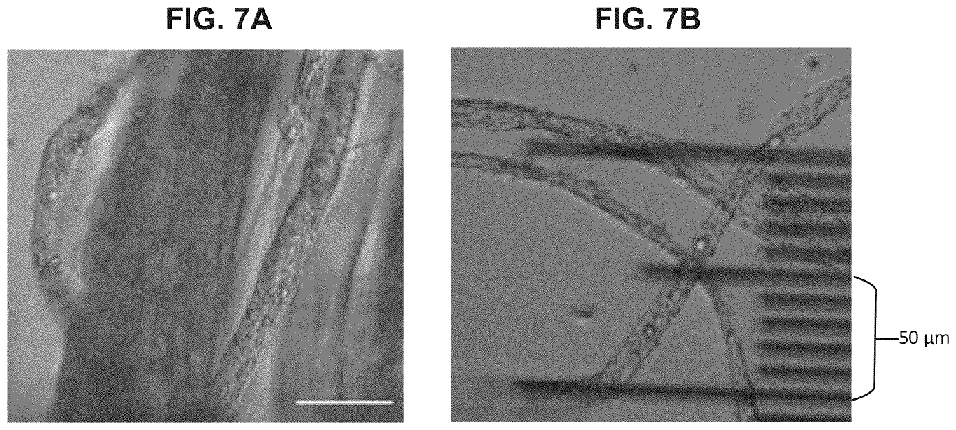

FIGS. 7A-7B show microscopic views of individual plant-based fibers. FIG. 7A shows a bundle of plant-based fibers soaked in water and agitated to release individual fibers. The scale bar in FIG. 7A is 50 μm. FIG. 7B shows the plant-based fibers dispersed on a microscope slide containing a microscale engraving, where individual scale lines are separated by 10 μm. As shown, the average fiber diameter of the fibers shown in FIGS. 7A-7B is 24.7±5.68 μm (standard error of the mean (s.e.m.), N=9).

Table 1 shows fiber diameters of plant-based fibers, as compared to raw beef steak fibers. Sample A Plant-Based Fibers were formed via by mixing 7 parts plant protein with 3 parts polysaccharide in water to form a dispersion that was then ejected via rotary jet spinning. Sample B Plant-Based Fibers were formed with slightly less protein than Sample A. As shown, plant-based fibers are only slightly thicker than raw beef steak fibers.

TABLE 1
Fiber Diameters of Plant-Based Fibers and Raw Beef Steak Fibers

| Sample | Fiber diameter (μm) ± s.e.m. | Count |
|---|---|---|
| Sample A Plant-Based Fibers | 24.7 ± 5.68 | 9 |
| Sample B Plant-Based Fibers | 55.87 ± 2.84 | 23 |
| Raw Beef Steak | 16.5 ± 1.19 | 20 |

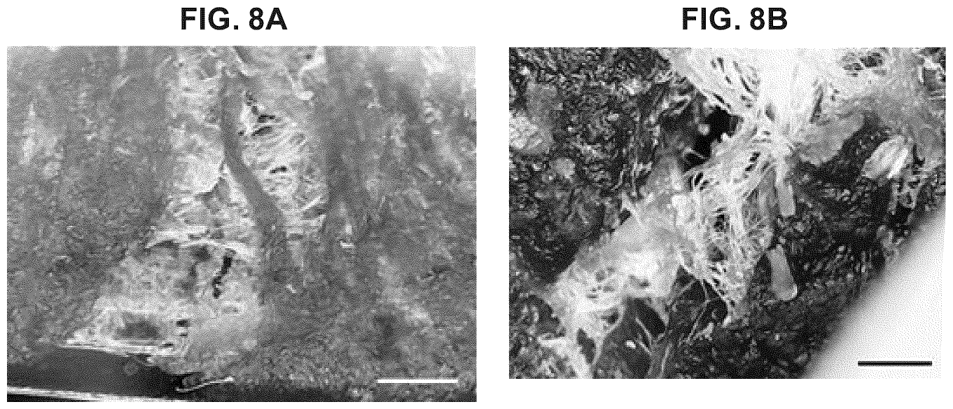

FIGS. 8A-8B show comparisons of a plant-based fiber scaffold, as compared to commercially available beef jerky. FIG. 8A shows a fiber scaffold of a collection of plant-based fibers. The fibers were formed via rotary jet spinning after soaking in red food dye and drying for two days. FIG. 8B shows commercially available Baja traditional beef jerky. The plant-based product and the beef jerky were both pulled apart to show their fibrous interiors. Scale bars of 1 μm are shown in both FIGS. 8A and 8B.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method of forming a fibrous food product, comprising:
mixing a composition with a solvent to form a first solution, the first solution including between about 15 wt % and about 40 wt % of the composition and between about 0 wt % and about 15 wt % of an oil, the composition including a plant protein and a polysaccharide;
causing ejection of a second solution in a jet;
collecting the jet of the second solution in a precipitation bath, such that a collection of fibers forms;
drying the collection of fibers; and
pulling apart the collection of fibers; and
adding a fat and a flavoring to the collection of fibers to form the fibrous food product.

2. The method of claim 1, further comprising:
drying the collection of fibers.

3. The method of claim 1, further comprising:
during the mixing and/or the rotating, heating the second solution to a temperature between about 40° C. and about 90° C.

4. The method of claim 1, further comprising:
adding acetic acid to the first solution, such that the first solution includes less than about 5 wt % of the acetic acid.

5. (canceled)

6. The method of claim 1, further comprising:
adding a base to the first solution, such that the first solution includes less than about wt % of the base.

7. The method of claim 1, wherein the polysaccharide includes at least one of sodium alginate, beta-glucans, carrageenan, methylcellulose, alginate, chitosan, glucans, pectin, konjac, pullulan, starch, curdlan, or trehalose.

8. The method of claim 1, wherein the fat includes at least one of coconut oil, canola oil, flaxseed oil, or sunflower oil.

9. The method of claim 1, further comprising:
adding biological cells to the collection of fibers.

10. The method of claim 9, wherein the biological cells are anchorage-dependent.

11. The method of claim 9, wherein the biological cells include at least one of mammalian muscle myoblasts, fish muscle myoblasts, avian muscle myoblasts, avian cells, fibroblasts, adipocytes, endothelial cells, epithelial cells, keratinocytes, cells from crustaceans, cells from mollusks, or stem cells.

12. The method of claim 1, wherein the drying is via at least one of pressing or spinning.

13. (canceled)

14. The method of claim 1, wherein the plant protein is from at least one of rice, peas, soy, barley, rice, barley rice, beans, fava beans, seitan, tempeh, edamame, lentils, chickpeas, nutritional yeast, spelt, teff, seeds, hemp seeds, amaranth, quinoa, spirulina, green peas, oats, Ezekiel bread, wild rice, nuts, chia seeds, or mycoprotein.

15. The method of claim 1, wherein the fibrous food product includes at least about 60% by weight of the plant protein.

16. The method of claim 1, further comprising:
adding at least one of a salt, a thiol, or mercaptoethanol to the collection of fibers to cleave disulphide bonds in the fibers.

17. The method of claim 1, wherein the solvent includes water.

18. The method of claim 17, wherein the solvent further includes ethanol, such that the collection of fibers forms in the precipitation bath via water-ethanol exchange.

19. The method of claim 1, wherein the first solution is an acidic solution, the method further comprising:
ejecting the acidic solution to the precipitation bath, the precipitation bath including a basic solution, such that the collection of fibers in the precipitation bath are formed via acid/base exchange.

20. The method of claim 1, wherein the ejection of the second solution is via at least one of single screw extrusion or twin-screw extrusion that are either co-rotating or counter-rotating.

21. (canceled)

22. The method of claim 1, wherein the ejection of the second solution is via at least one of electrospinning, blow spinning, wet spinning, or jet spinning.

22-25. (canceled)

26. A fibrous food product, comprising:
a collection of fibers suspended in the stabilizing liquid and having diameters ranging from about 10 μm to about 150 μm, the collection of fibers including:
at least about 20% by weight of a plant protein; and
a polysaccharide
between about 0% and about 80% by weight of water; and
an oil at least partially infused into the collection of fibers,
wherein the fibrous food product is heart-healthy, as defined by provisions of the FDA in 21 CFR § 101, Volume 2.

27. The fibrous food product of claim 26, further comprising:
a stabilizing liquid including an acid.

28. The fibrous food product of claim 26, wherein the oil includes at least one of coconut oil, canola oil, flaxseed oil, or sunflower oil.

29. The fibrous food product of claim 26, wherein the plant protein is from at least one of rice, peas, soy, barley, rice, barley rice, beans, fava beans, seitan, tempeh, edamame, lentils, chickpeas, nutritional yeast, spelt, teff, seeds, hemp seeds, amaranth, quinoa, spirulina, green peas, oats, Ezekiel bread, wild rice, nuts, chia seeds, or mycoprotein.

30. The fibrous food product of claim 26, wherein the polysaccharide makes up between about 0.25% and about 30% of the weight of the collection of fibers.

31. The fibrous food product of claim 26, wherein the polysaccharide includes at least one of sodium alginate, beta-glucans, carrageenan, methylcellulose, alginate, chitosan, glucans, pectin, konjac, pullulan, or trehalose.

32. The fibrous food product of claim 26, wherein the fibrous food product has a hardness value of about 2.3 to about 3.5 N, a springiness value of about 6.1 to about 6.9 N, a cohesiveness value of about 0.45 to about 0.55, a gumminess value of about 1.1 to about 1.9 N, and a chewiness value of about 0.6 to about 1.3 J on the textural properties of food scale.

33. (canceled)

34. (canceled)

35. The fibrous food product of claim 26, wherein the fibrous food product is free of any cells originating from a living animal.

36. The fibrous food product of claim 26, further comprising biological cells.

37. The fibrous food product of claim 26, wherein the fibrous food product has a Warner-Bratzler shear strength of about 0.5 kg to about 5 kg.

38. The fibrous food product of claim 26, wherein the fibrous food product includes a plurality of non-woven fibers.

39. The fibrous food product of claim 26, wherein the collection of fibers includes calcium.
